(19) United States
(12) Patent Application Publication
(10) Pub. No.: US 2003/0177283 A1
(43) Pub. Date: Sep. 18, 2003

(54) Application program interface

(76) Inventors: Thomas E. Hamilton, Marlborough, MA (US); Clifford S. Atwood, Harvard, MA (US)

Correspondence Address: FISH & RICHARDSON PC, 225 FRANKLIN ST, BOSTON, MA, 02110, US

(21) Appl. No.: 10/100,468

(22) Filed: Mar. 18, 2002

(51) Int. Cl. G06F 9/00; G06F 9/46

(52) U.S. Cl. 709/328

(57) ABSTRACT

A method in a network is provided. The method includes receiving messages from an application program in an application program interface (API), and passing the messages from the API to a control process in a mobile service switching platform (MSSP). A system is also provided. The system includes a Gateway General Packet Radio Service Support Node (GGSN) linked to control process in a Mobile Service Switching Platform (MSSP), a group of globally connected computers linked to the control process, an application program interface (API) connected to the control process, and an application system executing an application process linked to the API.

### TECHNICAL FIELD

This invention relates to an application program interface (API).

### BACKGROUND

In general, an application program interface (API) is a specific method prescribed by a computer operating system or by another application program by which a programmer writing an application program can make requests of the operating system or another application. More specifically, an API is a formalized set of software calls and routines that can be referenced by an application program in order to access supporting services.

### SUMMARY

In aspect, the invention features a method including, in a network, receiving messages from an application program in an application program interface (API), and passing the messages from the API to a control process in a mobile service switching platform (MSSP).

Embodiments may include one or more of the following. The network may be a wireless network. The wireless network be be a second generation wireless network, a GSM network, a GPRS-enabled GSM network or a TDMA network. The wireless network may be a CDMA network, a UMTS network, a TETRA network or a Tetrapol network. The wireless network may be a DECT network, an AMPS network, a WLAN or a third generation wireless network.

The API may provide a protocol that allows the application program to control switching and routing functions in the MSSP.

The API may provide a protocol that allows the application program to redirect packet flow through the MSSP on a per-flow basis.

The API may provide a protocol that allows the application program to control policy decisions within the MSSP.

The API may include a protocol that allows the application program to arm initial detection points (IDPs) and services associated IDP events in the control process.

The API may include a protocol that allows the application program to disarm IDPs and service associated ICP events in the control process.

The API may include a protocol that allows the application program to request event reports.

The API may include a protocol that allows the application program to specify programmed behavior at a detection point in the control process.

The API may include a protocol that allows the application program to configure data elements that are metered by the control process of the MSSP.

The API may include a protocol that allows the application program to request byte-based reporting. The reporting may be session-based or flow-based.

The API may include a protocol that allows the application program to specify a cost of services provided.

The API may include a protocol that allows the application program to record a charge plan used in a detail record and a protocol that allows the application program to control when the detail record is written.

The API may include a protocol that allows the application program to obtain statistics for a session managed by the application program.

The API may include a protocol that allows the application program to obtain statistics for a flow managed by the application program.

The API may include a protocol that allows the application program to monitor a status of other applications connected to the control process of the MSSP.

In another aspect, the invention features an application program interface (API) including a set of application layer protocols that allows exchange of messages between an application process and a control process of a Mobile Service Switching Platform (MSSP) using Transmission Control Protocol/Internet Protocol (TCP/IP) network services.

In embodiments the set of application layers protocols may include a protocol that allows the application process to arm initial detection points (IDPs) and services associated IDP events in the control process.

The set of application layers protocols may include a protocol that allows the application process to disarm initial detection points (IDPs) and services associated IDP events in the control process.

The set of application layers protocols may include a protocol that allows the application process to request event reports from the control process.

The set of application layers protocols may include a protocol that allows the application process to specify programmed behavior at a detection point in the control process.

The set of application layers protocols may include a protocol that allows the application process to configure data elements that are metered by the control process.

The set of application layers protocols may include a protocol that allows the application process to request byte-based reporting in the control process. The reporting may include session-based reporting or flow-based reporting.

The set of application layers protocols may include a protocol that allows the application process to specify a cost of services provided by the MSSP.

The set of application layers protocols may include a protocol that allows the application process to record a charge plan used in a detail record stored in the MSSP.

The set of application layers protocols may include a protocol that allows the application process to control when the detail record is written.

The set of application layers protocols may include a protocol that allows the application process to obtain statistics for a session managed by the application process.

The set of application layers protocols may include a protocol that allows the application process to obtain statistics for a flow managed by the application process.

The set of application layers protocols may include a protocol that allows the application process to monitor a status of other application processes connected to the control process.

In another aspect, the invention features a system including a Gateway General Packet Radio Service Support Node (GGSN) linked to control process in a Mobile Service Switching Platform (MSSP), a group of globally connected computers linked to the control process, an application program interface (API) connected to the control process, and an application system executing an application process linked to the API.

In embodiments, the system may include a General Packet Radio Service Support Node linked to the GGSN. The system may include a Base Station Controller (BSC) linked to the General Packet Radio Service Support Node. The system may include a Base Transceiver Station (BTS) linked to the BSC and a mobile station (MS) linked to the BTS.

The API may include a set of application layer protocols that allows exchange of messages between the application process and the control process.

The set of application layers protocols may include a protocol that allows the application process to arm initial detection points (IDPs) and services associated IDP events in the control process.

The set of application layers protocols may include a protocol that allows the application process to disarm initial detection points (IDPs) and services associated IDP events in the control process.

The set of application layers protocols may include a protocol that allows the application process to request event reports from the control process.

The set of application layers protocols may include a protocol that allows the application process to specify programmed behavior at a detection point in the control process.

The set of application layers protocols may include a protocol that allows the application process to configure data elements that are metered by the control process.

The set of application layers protocols may include a protocol that allows the application process to request byte-based reporting in the control process. Reporting may be session-based or flow-based.

The set of application layers protocols may include a protocol that allows the application process to specify a cost of services provided by the MSSP.

The set of application layers protocols may include a protocol that allows the application process to record a charge plan used in a detail record stored in the MSSP.

The set of application layers protocols may include a protocol that allows the application process to control when the detail record is written.

The set of application layers protocols may include a protocol that allows the application process to obtain statistics for a session managed by the application process.

The set of application layers protocols may include a protocol that allows the application process to obtain statistics for a flow managed by the application process.

The set of application layers protocols may include a protocol that allows the application process to monitor a status of other application processes connected to the control process.

Embodiments of the invention may have one or more of the following advantages.

The Application Program Interface (API) provides an application layer protocol that exchanges messages with a Mobile Service Switching Platform (MSSP) using simple TCP/IP network services that are available on almost all computer platforms.

The API provides a set of protocols that allow service logic contained in an external application program to control switching/routing functions of a Mobile Service Switching Platform.

The API provides a protocol for an operator to limit the scope of an application's detection points, in which a detection point is a defined place in a state machine of a control entity where application event reporting and/or control is possible.

The API provides a protocol that is common to all applications, regardless of application privileges.

The API provides a protocol that allows an application to arm and disarm Initial Detection Points (IDPs) in a Mobile Service Switching Platform (MSSP) and service associated IDP events, where an IDP is defined as a detection point armed so as to create a new control dialog with an application when conditions match given criteria.

The API provides a protocol that allows an application to request additional event reports subsequent to an Initial Detection Point event. When the IDP that initiates a control dialog is a trigger, the application typically requests additional event reports.

The API provides a protocol that allows an application to specify programmed behavior at a Detection Point (DP) that does not require the involvement of the application. Messages are used to match incoming requests to determine if the predefined service interaction should be executed. The matching process is similar to the process used for Initial Detection Points in general and wildcards may be used in the fields to be matched. If a flow matches the criteria, the actions specified in the remainder of the message will be carried out with no application involvement. Actions that may be specified include the reporting of events as well as redirecting a request to a specified redirection address and port number. A message is used to determine which events will be reported in the future for the flow if event reports are required. Criteria to be matched may not overlap with armed Initial Detection Point criteria. If the request cannot be completed for any reason a message will be returned with a matching RequestID and an error code indicating the nature of the failure. If the request completes successfully, another message is returned. Service Filtering remains active until cancelled by a specific message request.

The API provides a protocol that allows an application to configure data elements that are metered by a Mobile Service Switching Platform (MSSP).

The API provides a protocol that allows an application to request byte based reporting. Reporting may be requested on a session or flow basis. Session based charge notification effectively causes the same charge notification criteria to be applied to all flows in the session. Registering for charge notification events causes the number of bytes of the specified type transferred in uplink and downlink directions to be metered. Each time a reporting threshold is reached a message is sent from the MSSP to the application indicating the number of bytes that have been transferred, and counters are reset and begin counting towards the threshold again. Charge notification continues until the flow terminates or charge notification is explicitly cancelled by a cancel request. A packet is the atomic unit counted and each packet either falls before the count is evaluated or after the count is evaluated. As a result, charge notification may not occur exactly on the byte count specified. For example, if notification was requested every 10K bytes, the notification may occur at 10.5 Kbytes if the packet that brought the count over 10K was slightly greater than 500 bytes. The actual counter values are provided in a message.

The API provides a protocol that allows an application to indicate a cost of the services provided and record a charge plan used in an MSSP detail record.

The API provides a protocol that allows an application to control when MSSP detail records are written.

The API provides a protocol that allows an application to obtain various statistics for a session or flow managed by the application.

The API provides a protocol that allows an application to monitor the status of other applications connected to the same MSSP instance.

The API provides a protocol that allows the redirection of packet flow on a per-flow basis.

Other features, objects, and advantages of the invention will be apparent from the description and drawings, and from the claims.

### DESCRIPTION OF DRAWINGS

FIG. 1 is a block diagram of a network.

FIG. 2 is a flow diagram of an interception process.

FIG. 3 is a flow diagram of the service application startup stage of FIG. 2.

FIG. 4 is a flow diagram of the service initialization stage of FIG. 2.

FIG. 5 is a flow diagram of the service deployment stage of FIG. 2.

FIG. 6 is a flow diagram of the service logic stage of FIG. 2.

FIG. 7 is a flow diagram of the shutdown stage of FIG. 2.

FIG. 8 is a table of data types used by the API of FIG. 1.

FIG. 9 is a block diagram of a communication path.

FIG. 10 is a block diagram of a TCP/IP byte stream divided into session messages by the transport layer.

FIG. 11 shows a table listing sample error codes.

FIG. 12 shows a table listing sample feature categories.

### DETAILED DESCRIPTION

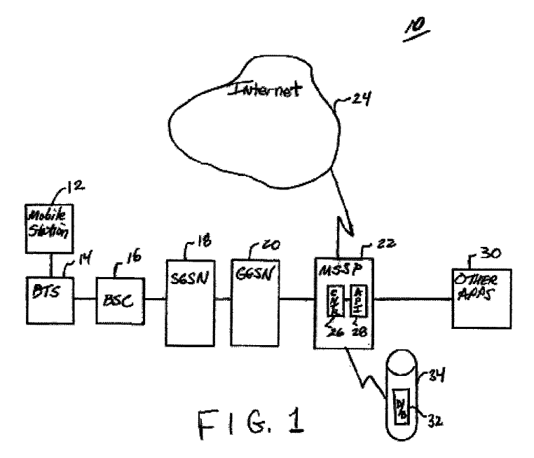

Referring to FIG. 1, a network 10 is shown. The network 10, for example, may be a wireless network. The wireless network may be, for example, a second generation wireless network, a Global System for Mobile Communications (GSM) network, or a General Packet Radio System (GPRS) enabled GSM. The wireless network may be a Time Division Multiple Access (TDMA) network, a Code Division Multiple Access (CDMA) network, or a Universal Mobile Telecommunications System (UMTS) network. The wireless network may be a TETRA network, a Tetrapol network, a DECT network, an AMPS network, a wireless local area network (WLAN) or a third generation wireless network. By way of example, a GPRS enabled GSM network is described.

The network 10 includes a Mobile Station (MS) 12 connected to a Base Transceiver Station (BTS) 14. The BTS 14 is connected to a Base Station Controller (BSC) 16. In mobile communications, the MS 12 is a station located within a mobile service intended to be used while in motion or during halts at unspecified points. An example mobile station is a hand held cellular telephone.

The BTS 14 holds radio transceivers that define a cell and coordinates radio-link protocols with the MS 12. The BTS 14 is a component of the network 10 from which all signals are sent and received. The BTS 14, often called a cell phone tower, is linked to, and controlled by, a Base Station Controller (BSC) 16. The BSC 16 is a component in the network 10 that manages radio resources for one or more base transceiver stations, such as BTS 14, for example.

The BSC 16 is linked to a SGSN 18. The SGSN 18 is a General Packet Radio Service Support (GPRS) Node that serves GPRS mobile by sending or receiving packets via the BSC 16. The SGSN 18 is linked to a Gateway GPRS Support Node (GGSN) 20. The GGSN 20 acts as a gateway between a General Packet Radio Service (GPRS) network and a Packet Switched Public Data Network (PSPDN).

The GGSN 20 is linked to a Mobile Service Switching Platform (MSSP) server 22. The MSSP server 22 resides between the GGSN 20 and a globally networked group of computers, such as Internet 24. The MSSP server 22 analyzes all of the Internet Protocol (IP) data packets exchanged between the MS 12 and the Internet 24. A MSSP control process 26 provides the capability to set triggers or event notifications and increment counters based on IP flow characteristics. An IP flow can be thought of as an abstraction representing a movement of data between two endpoints, such as MS 12 and a server (not shown) residing on the Internet 24. The MSSP control process 26 uses these capabilities to implement internal services and detail reporting. An Application Program Interface (API) 28 links the MSSP control process 26 to external applications 30. The API 28 provides a mechanism for the external applications 30 to control the MSSP control process 26 to provide intelligent services. The API 28, in various embodiments, may be implemented as, for example, a Corba based API, an XML based API, a PARLAY server, an OSA Server, or a JAIN server.

Briefly, the MSSP server 22 functions as both an Internet router and an IP packet analyzer. Data contained in a header field of an IP packet is defined in the Internet Engineering Task Force (IETF) RFC 791, incorporated herein by reference (see www.ietf.org). The IETF is a large open international community of network designers, operators, vendors, and researchers concerned with the evolution of the Internet architecture and the smooth operation of the Internet.

The Internet Protocol (IP) is designed for use in interconnected systems of packet-switched computer communication networks. IP provides for transmitting blocks of data called datagrams from sources to destinations, where sources and destinations are hosts identified by fixed length addresses. The IP also provides for fragmentation and reassembly of long datagrams and, if necessary, for transmission through “small packet” networks.

The MS SP control process 26 is designed to analyze 1P packet headers in real time to manage counters and signal when packet characteristics match specified conditions. A signal may be an event report or a trigger. An event report reports an occurrence of some event while continuing to monitor packet flow. A trigger causes processing of the IP packet to be suspended until the MSSP control process 26 responds with specific instructions for resuming processing of the IP packet. A trigger response may simply direct IP packet processing to be continued unchanged, or it may altar packet processing by specifying a different destination for the packet or cause the packet to be discarded altogether. The API 28 provides, in one example, a way for the other applications 30 to communicate with the MSSP control process 26 and manipulate event reports and triggers.

The MSSP control process 26 manages many different types of IP packets. In one example, the MSSP control process 26 is divided into different state machines (not shown), each state machine responsible for different types of packets. In general, a state machine is any device that stores the status of something at a given time and can operate on input to change the status and/or cause an action or output to take place for any given change. In practice, state machines are used to develop and describe specific device or program interactions.

Within each state machine of the MSSP control process 26 there are strategic places where important information becomes available or key decisions are made. These places are called detection points. A detection point (DP) is a defined place in a state machine of a control entity where application event reporting and/or control are possible, and manageable through the API 28.

An Event Detection Point (EDP) is a detection point armed within the context of an existing control dialog. Event detection points do not have explicit criteria; they are only applicable to a specific state machine instance of a control entity that generated the control dialog. In general, event detection points set within one control dialog do not affect a behavior of any other instance of that state machine. A complete set of detection points in a given state machine is known as a detection point class.

One of the most commonly used Internet protocols is the Transmission Control Protocol (TCP), which is defined in IETF RFC 793. By way of example, detection points using a TCP detection point class will be discussed below. However, it should be realized that other protocols might be utilized.

TCP provides a reliable, connection oriented communication path between two application processes (usually referred to as a client and a server). The client initiates a connection and the server accepts the connection before any data can be exchanged. The TCP protocol ensures that all of the data sent is received by the other side correctly and in the order that it was sent.

In order to initiate a TCP connection to a server, a client sends an IP packet to the server's IP address containing a TCP header with a “SYN” flag set and specifying a port number of the server application that it wishes to connect to. The server accepts the connection by sending a similar SYN packet back to the client, and the client acknowledges the SYN from the server by sending an IP packet containing a TCP header with the “ACK” flag set.

Packets pass through the MSSP control process 26 in the MSSP server 22 on their way between a client, e.g., MS 12, and a server (not shown) residing on the Internet 24. By examining the IP header of the packets, the MSSP control process 26 determines that the IP packet encapsulates TCP data and assigns the packet to TCP control logic. By examining the data in the TCP header in conjunction with the data in the IP header, the TCP control logic can distinguish each segment of the connection establishment.

For example, suppose that one of the service applications 30 would like to “intercept” TCP connections to a specific server on the Internet 24 and redirect them to different servers on the Internet 24, perhaps based on the service application's knowledge of current server load conditions. The service application 30 can instruct the MSSP control process 26 through the API 28 to generate a trigger that watches for a TCP SYN packet that has a destination that matches the server to be intercepted. This is referred to as an Initial Detection Point (IDP). An IDP is a detection point armed so as to generate a new control dialog with an application when conditions match given criteria.

All other TCP packets, and TCP SYN packets directed to a different destination, continue to be processed normally. A TCP SYN packet with a destination that matches the arming criteria, however, causes processing of that packet to be suspended and an IDP event notification sent to the service application 30 that armed the IDP through the API 28.

The IDP event notification may include, for example, information from the suspended packet that the service application 30 may use to determine a correct destination for the connection. The service application 30 then directs the MSSP control process 26 through the API 28 to resume packet processing with a different destination address. The MSSP control process 26 forwards a modified TCP SYN packet to the new destination, where that server responds in a typical manner. The service application's involvement is completely transparent, i.e., neither the client, e.g., MS 12, nor the server (not shown) on the Internet 24 is aware that any redirection has taken place.

Service applications 30 interact with the MSSP control process 26 by exchanging TCP/IP messages. The API 28 listens for connections from service applications 30. When an application connection is made, the API 28 authenticates the identity of the connected service application 30 and looks up the features that the application is authorized to access.

The service application 30, once its communication session with the API 28 is established, requests a list of services that it is expected to provide from the MSSP control process 26 and then arms Initial Detection Points needed to implement those services. After that, the service application 30 waits for the MSSP control process 26 to signal when it has a packet that matches the arming criteria.

When the MSSP control process 26 signals an IDP event, the service application 30 applies its service logic (not shown) through the API 28. This service logic may, in addition to directing the packet to a chosen destination, configure additional metering for the packet flow that encountered the detection point, request additional event reports from this flow, indicate a charge plan that is applicable to the flow, request periodic charge notification events, or request flow statistics.

In an example, using an activate service filtering request message of the API 28, a default behavior of a service interaction between the MSSP control process 26 and the service logic of the application 30 may be specified without the need to implemenet a trigger detection point. A source address, source port, destination address string within a data portion of a packet and protocol port are used to match incoming requests to determine if a predefined service interaction should be executed. If a flow matches the criteria, the actions specified in the remainder of the message are carried out. Example actions that may be specified include the reporting of events as well as redirecting a request to a specified redirection address and port number.

In another example, the service logic begins execution when an IDP is detected. The service logic receives an event notification that the detection point was encountered. If the detection point is registered as a request detection point, the service logic responds when the MSSP request instruction within a timeout period. The response may modify the packet then forward it, release the flow or session, or redirect or connect the packet using the connect request. Other requests may also be made to program policy filters to be applied to flow or session. Optionally the service filter request may be used by the service logic to specify the service interaction to be carried out when the detection point is encountered.

For example, the API 28 provides a connect request message that instructs the MSSP control process 26 to establish a connection to a specified destination address on a flow that is suspended at a trigger point. The destination address may be different than the desitination address in the packet that matched the trigger condition. This allows the service logic in the service application 30 to, for example, route connections to a best available resource.

The API 28 provides a release flow message that instructs the MSSP control process 26 to terminate an active flow. The MSSP control process 26 will terminate the flow and may provide any events or metering messages following confirmation of the termination.

Thus, using the API 28, the service application 30 manages and controls sponsored packet switched data services, which include any and all unique network addresses that identify the packet switched data service, the policy decisions that determine how, and to which, packet switched data service provider the user is directed (e.g., a specific server on the Internet 24), and the policy decisions that determine which sponsor is to be billed for the session and on what basis. Policy filters may be used to block IP traffic in either direction based on port, protocol, IP address, cookies, or other layer seven protocol characteristics. The policy filters also allow the service logic to create and manage a wall garden or subscription based model. The policy filters are dynamic in nature, allowing new services to be purchased dynamically and updated by the service logic.

The policy decisions for selection and billing may include rules that incorporate pre-agreements between an operator and third parties, either sponsors or service providers, as to the selection of the service provider and the method and basis of payment for the sponsor. A policy decision of which service provider to make a connection to may be made at the time of the service request based upon such factors as a user identity, a location of the user, a time of day, a user class, a service provider class, network conditions, pre-agreement rules, and/or governmental regulations. For example, a policy decision of which sponsor to bill and on what basis can be made at time of the service request based upon similar factors such as the user identity, the location of the user, time of day, user class, service provider class, network conditions, pre-agreement rules, and/or governmental regulations.

A service interaction is defined by the service logic as having a beginning, middle, and end. The beginning of service interaction is typically identified by an IDP (Initial Detection Point) event sent to the service logic when the detection point is encountered. The service interaction will end when there are no further events registered by the service logic or the service logic explicitly terminates the dialogue. The service interaction is bounded by the sequence of events and API calls received and made by the service logic between the IDP and the terminal event. A service interaction is usually billable event that causes the service logic to write a CDR following the end of the interaction. The details of service interaction boundaries are determined by the service logic. A stock quote service for example may begin when an IDP matching the request is reported, and end on the response containing the quote. This same example can be expanded to include, for example, file downloads and email delivery. The MSSP provides the means to detect and control an interaction and the service logic is responsible for making the API calls and processing events to implement the service.

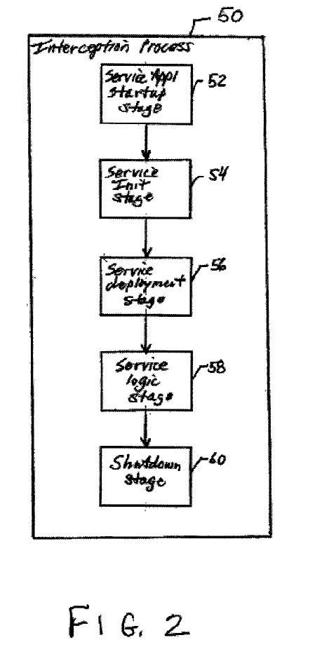

Referring to FIG. 2, using TCP as an example, an interception process 50 includes a service application startup stage 52, a service initialization stage 54, a service deployment stage 56, a service logic stage 58 and a shutdown stage 60.

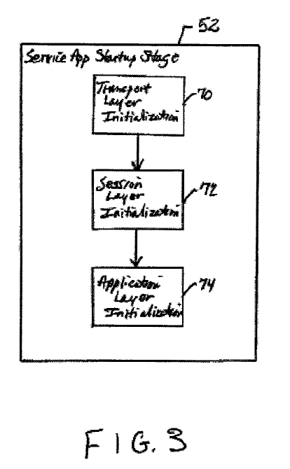

Referring to FIG. 3, the service application startup stage 52 includes initializing (70) a transport layer. The transport layer is initialized (70) by creating a TCP/IP socket and connecting the socket through the API 28. The stage 52 initializes (72) a session layer. The initialization (72) includes sending a session open request to the MSSP server 22. The MSSP server 22 authenticates the application's credentials. A session open confirmation is received from the MSSP server 22. The stage 52 initializes (74) an application layer. The initialization (74) includes sending a negotiate API version request and receiving a negotiate API version confirmation. An open request is sent and confirmed.

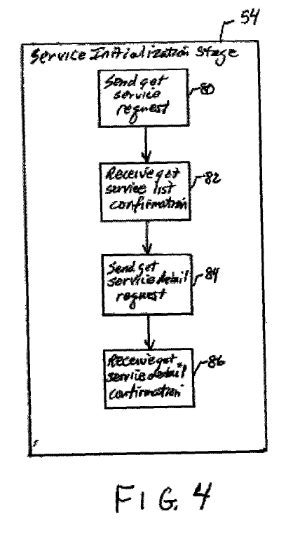

Referring to FIG. 4, the service initialization stage 54 includes sending (80) a get service list request; the MSSP server 22 looks up the services for this application. The stage 54 receives (82) a get service list confirmation and sends (84) a get service detail request; the MSSP server 22 looks up configuration data for the service. The stage 54 receives (86) a get service detail request confirmation.

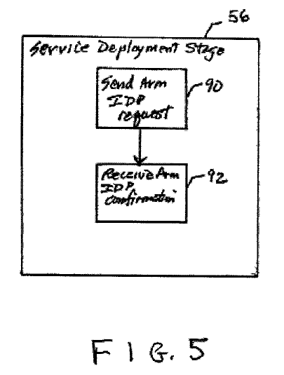

Referring to FIG. 5, the service deployment stage 56 includes sending (90) an Arm IDP request and receiving (92) an Arm IDP confirmation. The MSSP server 22 verifies that the arming criteria meets any restrictions configured for the application and service and programs the ICP criteria into the MSSP server 22.

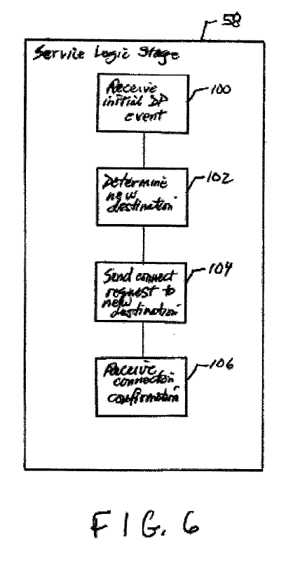

Referring to FIG. 6, the service logic stage 58 includes receiving (100) an initial DP event. The stage 58 determines (102) a new destination for the subscriber connection and sends (104) a connect request to the new destination. The stage 58 receives (106) a connect confirmation.

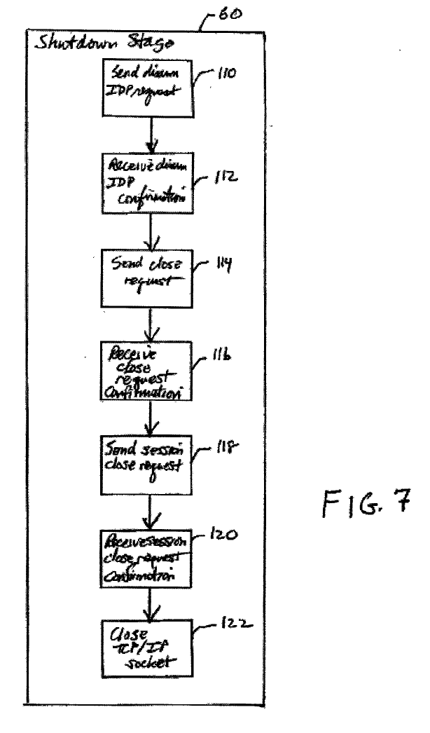

Referring to FIG. 7, the shutdown stage 60 includes sending (110) a disarm IDP request and receiving (112) a disarm IDP confirmation. The stage 60 sends (114) a close request and receives (116) a close confirmation. The stage 60 sends (118) a session close request, receives (120) a session close confirmation, and closes (122) the TCP/IP socket.

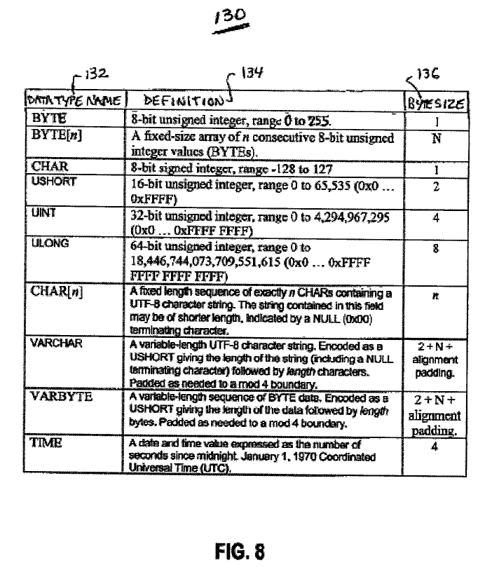

Referring to FIG. 8, a table 130 shows a set of data types utilized to define fields within messages used by the API 28. The table 130 includes a data type name 132, a definition 134, and a byte size 136. CHAR[n] refers to a UTF-8 character string. UTF-8 is a character encoding scheme in which the entire set of ASCII characters are encoded in one byte with the same encoding as ASCII while also allowing any of the full range of Unicode characters to be encoded using multiple-byte sequences in which no byte contains an ASCII character value.

All numeric data of more than one byte in length is transmitted in a canonical network byte order defined by TCP/IP standards, i.e., in order of most significant byte to least significant byte. It should be noted that to ensure application correctness and portability, application developers are encouraged to use their platform's host-to-network and network-to-host conversion functions (such as hton1( ) and ntoh1( ) even when the host platform is known to use network byte order. hton1( ) is an example UNIX function that converts 32-bit (4-byte) quantities from host byte order to network byte order, while ntoh1( ) is an example UNIX function that converts 32-bit quantities from network byte order to host byte order.

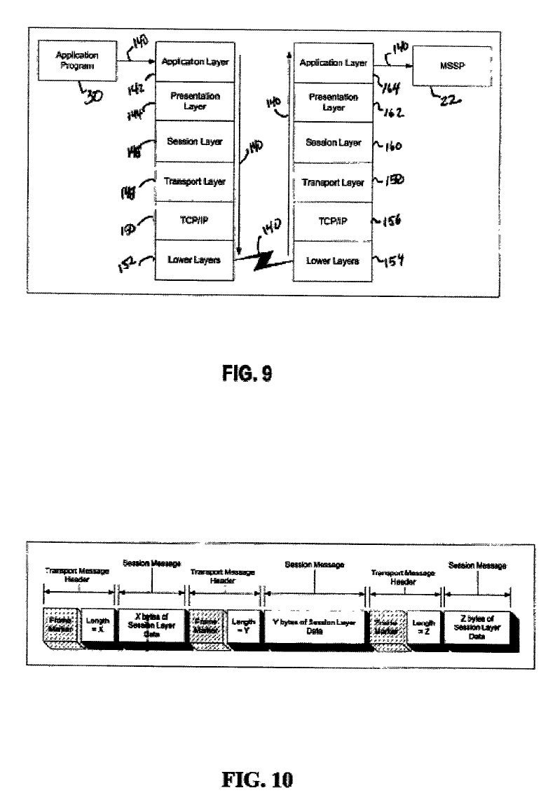

Referring to FIG. 9, a communication path 140 (indicated by the arrows) between an application program 30 and the MSSP server 22 uses a layered architecture. The application program 30 transmits data through its system's application layer 142, presentation layer 144, session layer 146, transport layer 148, TCP/IP layer 150 and lower layers 152, to corresponding lowers layers 154, TCP/IP layer 156, transport layer 158, session layer 160, presentation layer 162 and application layer 164 of the MSSP SERVER 22.

The transport layer 158 is used to provide a reliable transport to the session layer 160. The transport layer 158 is relatively lightweight since it is layered on top of the local TCP/IP layer 156, which by definition is reliable. The transport layer 158 receives messages from the session layer 160 that are then transmitted. The transport layer 158 separates the byte stream provided by the TCP/IP layer 156 into messages that are framed by a transport header.

In general, a frame is data that is transmitted between network points as a unit complete with addressing and necessary protocol control information. A frame is usually transmitted serial bit by bit and contains a header field and a trailer field that “frame” the data.

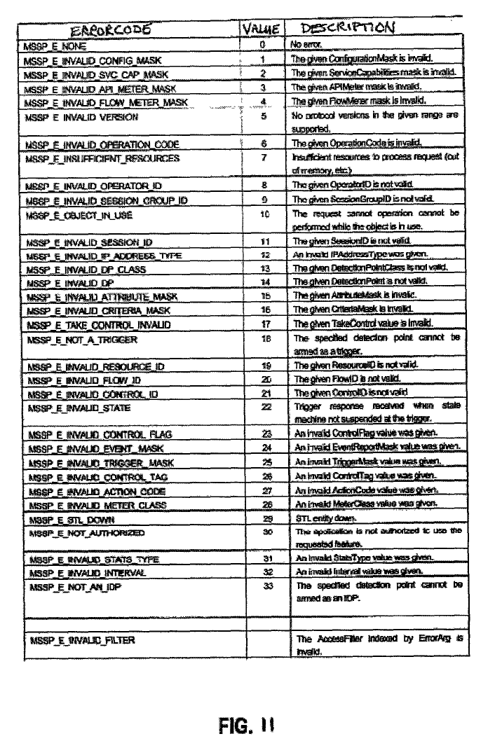

Referring to FIG. 10, a representation of a TCP/IP byte stream divided into session messages by the transport layer is shown. A frame marker, unlike some other protocols, does not itself determine a boundary of a transport message header. The frame marker data pattern may also be present elsewhere in a TCP/IP byte stream with no adverse effects or special encoding. The frame marker provides a means to detect common programming errors (such as improper byte ordering or length calculation errors) that might otherwise cause a receiver to incorrectly interpret some other data as a transport message header and take inappropriate action.

The API 28 uses an 8-byte transport message header as the first element in a message. The 8-byte transport message header includes a 4-byte INIT “framemarker” field that is a constant value used to verify the presence of a valid transport message header. Any other value is indicative of a message framing error. The 8-byte transport message header also includes a 4-byte “messagelength” field and contains an UNIT data type representing the length, in bytes, of the message data that follows.

The API 28 utilizes session level interfaces built on top of the reliable TCP/IP transport layer that guarantees a message will arrive. This session layer provides a set of session level services to the application layer. These services include authentication, session level heartbeats, and session level acknowledgements.

In general, a heartbeat monitors the status of a communication link and identifies when the last of a string of messages is not received. When either end of a connection has not sent any data for a specified number of seconds, it will transmit a heartbeat message. When either end of the connection has not received any data for a specified number of seconds, it will transmit a test request message. If there is still no heartbeat message received after the same time then the connection is considered lost and corrective action initiated.

All messages exchanged at the session layer include a header of four USHORT 2-byte fields as the first element in the message. The header is referred to as a session message header and includes a SessionMessage type field, a SessionInstance field, a SessionSendSeqNo field and a SessionReceiveSeqNo field.

The SessionMessage Type field contains a value that identifies the type of message and the format of the message data. The SessionInstance field contains a value that uniquely identifies the session instance. The SessionSendSeqNo field contains the send sequence number of the message. The SessionReceiveSeqNo field contains the send sequence number from the last received message.

All session messages include a pair of sequence numbers in the Session Message Header that are set by the sender and verified by the receiver. Each sender starts at zero and increments the send sequence number for each message sent. In addition, each sender keeps track of the next SessionSendSeqNo it expects to receive. Every message sent includes this number pair. The sequence numbers are used to detect lost session messages as well as provide a means to acknowledge receipt of data. The periodic exchange of sequence numbers in session heartbeat messages ensures that the sequence numbers remain up to date in the event that the session is idle with respect to SessData messages.

The session layer protocol version is negotiated during an open sequence. A client specifies a desired version of the protocol to be used for the duration of the session. The client initially specifies the highest version of the protocol supported by the client. A server examines the requested version number and compares it against the versions it supports. If the requested version is in the range of versions supported by the server, the acceptance of the version is indicated in a subsequent SessOpenConf message. If the client has requested a version beyond those supported by the server, the server responds with a SessOpenConf message indicating that the session has been established using the highest version supported by the server. This version will be different from what was originally requested by the client. In the event that the server cannot find a mutually supported protocol version a SessError message with an error code of MSSP_E_INVALID_VERSION is sent and the session is closed.

Similarly, session layer options are negotiated during the open sequence. The client specifies the desired protocol options to be used for the duration of the session. The client should always initially specify all options supported by the client. The server examines the requested options mask and chooses those options that it supports. The resulting mutual session options are communicated to the client in the subsequent SessOpenConf message. If the client is unable to function as a result of the options being reduced by the server, a SessError message with an error code of MS SP_E_INVALID_OPTIONS is sent to the server and the session closed.

Similarly, a heartbeat interval is negotiated during the open sequence. The client specifies its desired heartbeat interval in the SessOpenReq message, and the server responds with the heartbeat interval that the client should use in the subsequent SessOpenConf message.

A client and server exchange credentials during a session establishment sequence. The client provides an encrypted Session Security Descriptor that is the MD5 message-digest of the SessOpenReq message (excluding the SessionSecurityDescriptor field) encrypted using a private key of a public/private key pair. The MD5 message format is designed by RSA Data Security, Inc. and defined in IETF RFC 1321 (see www.ietf.org). Since a given application will likely open its session the same way every time, a random number field is provided in the message in order to prevent generating a “constant” message digest value and a resulting predictable Session Security Descriptor. The MSSP server 22 configuration of the application contains the public key of the public/private key pair. Upon receipt of the security descriptor in a SessOpenReq message, the server looks up the application in the MSSP server 22 configuration to obtain the client's public key, decrypt the given security descriptor using the public key, and verify that the decrypted result exactly matches the MD5 message-digest generated from the received message. If the credentials fail to validate, the server responds with a SessError message with an error code of MSSP_E_AUTH_FAILURE. If a number of successive failures occur in a unit amount of time, the server suspends listening for connection requests for a period of time not less than one minute.

If the credentials pass validation, the server provides a SessionSecurityDescriptor (that is the MD5 message-digest of the SessOpenConf message (excluding the SessionSecurityDescriptor field)) encrypted using the private key of a different public/private key pair) to the client in the SessOpenConf message. The client decrypts the descriptor using the server's public key and authenticates the server. If the validation of the server credentials fail on the client side of the connection, the client sends a SessError message with an error code of MSSP_E_AUTH_FAILURE. If a number of successive failures occur in a unit amount of time, the client suspends connection requests for a period of time not less than one minute.

The SessOpenReq message is used to begin a session-level exchange of information between an application and the API 28. The SessOpenReq message is the first message that is after a transport layer connection has been established as described above. The SessOpenReq message has the following format:

An 8-byte SessionHeader field that is a session header with a SessionMessage Type equal to Sess_Open_Req. A 4-byte UNIT SessionVersion field that represents a session protocol version supported by the client. A 4-byte UNIT SessionOptionsMask field that represents a bitwise combination of all the session layer options supported by the client. A 4-byte UNIT SessionHeartbeatInterval field that represents the nominal interval between exchanges of session heartbeat messages in seconds. A 4-byte UINT SessionApplicationID field that represents a MSSP server 22 determined value uniquely identifying this client application in the MSSP server 22. A 4-byte UNIT SessionRandonNum field represents any unpredictable value and is used to prevent predictable SessionSecurityDescriptor. A 16-byte BYTE[16] SessionSecurityDescriptor field representing a session security descriptor that is a MD5 message-digest of the message (excluding this field) encrypted using the client's private key of a public/private key pair. The server decrypts the session security descriptor using its copy of the client's public key to authenticate the client.

The SessOpenConf message is used to complete an establishment of a session and communicate a result of negotiated parameters. This message is sent as the successful response to a SessOpenReq message and has the following format:

An 8-byte SessionHeader field representing a session header with SessionMessageType SESS_OPEN_CONF. A 4-byte UINT SessionVersion field represents a session protocol version chosen for use by the server. A 4-byte UNIT SessionOptionsMask field representing a bitwise combination of all of the client session layer options chosen by the server. A 4-byte UNIT SessionHeartbeatInterval field representing a nominal interval between exchanges of session heartbeat messages in seconds. A 4-byte UNIT SessionServerID field represents a value uniquely identifying this MSSP SERVER 22 instance. A 4-byte UNIT SessionRandonNum field represents any unpredictable value and is used to prevent predictable SessionS ecurityDescriptor. A 16-byte BYTE[16] SessionSecurityDescriptor field representing a session security descriptor that is the MD5 message-digest of the message (excluding this field) encrypted using the server's private key of a public/private key pair. The client should decrypt the session security descriptor using its copy of the server's public key to authenticate the server.

A session requires that the client and server participate in a session maintenance procedure. The session maintenance procedure ensures that inactive or idle sessions are functional as well as ensuring that the response time is within reasonable limits. The session maintenance procedure is performed independent of whether or not other data is transmitted on the session. The session maintenance procedure includes the exchange of a SessHeartbeatReq message, followed by a SessHeartbeatConf message. The session maintenance procedure is initiated from the client side of a connection by sending a SessHeartbeatReq message. The server performs a set of operations to ensure the server is functioning properly and returns a SessHeartbeatConf message if all is well. If the server fails to respond within the heartbeat interval the client fails the session by sending a SessError message with an error code of MSSP_E_HEARTBEAT_TIMEOUT to the server. The client makes heartbeat requests at a periodic interval as specified in the SessOpenConf message at the time the session was established. The first client heartbeat is sent upon receiving the SessOpenConf message. Upon sending a SessHeartbeatReq message, a client timer is set to the heartbeat interval and a SessHeartbeatReq sent when the timer expires. The server expects to see a heartbeat request within the specified heartbeat interval. The server sets a timer following the transmission of the SessOpenConf message and the timeout will be set to twice the heartbeat interval. If the timer should expire and a heartbeat request is not received, the server fails the session by sending a SessError message with an error code of MSSP_E_HEARTBEAT_TIMEOUT. Each time a new heartbeat request is received, the server side timer is reset. At any given instant only one heartbeat request is outstanding. Note that the heartbeat messages will also be used to acknowledge DATA messages or detect errors related to mismanagement of sequence numbers on an idle session connection.

The SessHeartbeatReq message is used to request verification that the session partner is operating normally and has the following format:

An 8-byte SessionHeader field representing a session header with SessionMessageType=SESS_HEARTBEAT_REQ. A 4-byte UNIT SessionHeartbeatInstance field representing a value that uniquely identifies a given heartbeat in the session. A 4-byte TIME SessionTimeStamp field represents a time that the heartbeat request was issued. A 4-byte UNIT SessionHeartbeatInterval field representing a nominal interval between exchanges of session heartbeat messages, in seconds. This may be different than the current heartbeat interval when the sender desires to negotiate a new heartbeat interval.

The SessHeartbeatConf message is used to complete the verification of the session partner's normal operational status. This message is sent as the successful response to a SessHeartbeatReq message. The SessHeartbeatConf message has the following format:

An 8-byte SessionHeader field represents a session header with SessionMessageType equal to SESS_HEARTBEAT_CONF. A 4-byte UNIT SessionHeartbeatInstance field represents the same SessionHeartbeatInstance value that was given in the corresponding heartbeat request. A 4-byte TIME SessionTimeStamp field represents the same SessionTimeStamp value that was given in the corresponding heartbeat request. A 4-byte UNIT SessionHeartbeatInterval field representing a nominal interval between exchanges of session heartbeat messages, in seconds. This may be different than the current heartbeat interval when a new heartbeat interval has been negotiated.

A session may be closed by either client or server at anytime following successful session establishment. A client or server initiates the closure procedure by sending a SessCloseReq message to the session partner. The SessCloseReq message contains a code indicating the reason for the closure. The requesting session partner shutdowns (in the socket sense) the transport layer following the transmission of the SessCloseReq message. The receiving session partner notifies the application layer to allow any outstanding requests on the session to be completed. Any queued session messages are sent prior to the transmission of the SessCloseConf message. Once the SessCloseConf message is sent, the transport connection shutdowns and the socket connection is closed from the side that requested the session be closed. A client may time-out a close request if a server fails to respond within a reasonable period of time. If a close request is timed-out by a client, a SessError message is sent to the server with an error code of MSSP_E_CLOSE_TIMEOUT. If a session partner is unable to process a close request because a session has not been previously opened at the time of a close request, a SessError message is sent to the requesting partner with an error code of MSSP_E_NO_SESSION. If a session is active or initialized and the session partner is unable to process a close request for any reason, the receiver sends a SessError message to the requester with an error code of MSSP_E_UNSPECIFIED_FAILURE.

The SessCloseReq message is used to initiate the orderly termination of a session and has the following format:

An 8-byte SessionHeader field representing a session header with SessionMessageType=SESS_CLOSE REQ. A 4-byte UNIT SessionCloseReasonCode field represents a value indicating a reason for the closure of the session. MSSP reason codes include, for example, normal operation, partial detail during normal operation, normal shutdown, subscriber logout, flow timeout and session timeout.

SessCloseConf message is used to complete an orderly termination of a session. This message is sent as the successful response to a SessCloseReq message and has the following format:

An 8-byte SessionHeader field representing a session header with SessionMessageType=SESS_CLOSE_CONF.

One purpose of establishing a session is to exchange data between a client and a server. Data messages may be exchanged between parties following the completion of the session open sequence. The session layer does not interpret data messages. Received data messages are forwarded to the application layer for processing. Only the bytes contained in the SessionData field of a SessData message are forwarded to the application layer. This effectively removes the session portion of the message prior to passing it to the application. Messages received from the transport layer are also devoid of any transport layer headers or data, and the messages are complete prior to processing. The converse is also true when transmitting data. The session layer encapsulates the application data in a session data message that is forwarded to the transport layer for transmission.

A SessData message SessData is used to transmit application layer data to the session partner and has the following format:

An 8-byte SessionHeader field representing a session header with SessionMessageType=SESS_DATA. A variable length SessionData field representing data to be delivered to the application layer.

A session may fail from time to time due to communication or process failures. In the event of a session failure, the failure is reported asynchronously under the context of the session partner detecting the failure. Either the client or the server side may send a SessError message. A SessError message may be sent at anytime from the client side following the SessOpenReq message. A SessError message may be sent at anytime from the server side including as a response to a SessOpenReq. A SessError message contains an error code indicating the reason for the failure. The session partner may or may not receive the SessError message depending upon the nature of the error. Following the transmission or receipt of a SessError message, data may not be sent over the session and the underlying transport connection should be shutdown and closed.

The SessError message is used to inform a session partner of an error condition that will prevent further session level communication; it has the following format:

An 8-byte SessionHeader field representing a session header with SessionMessageType=SESS_ERROR. A 4-byte UNIT SessionErrorCode field represents a value indicating a cause of the session failure.

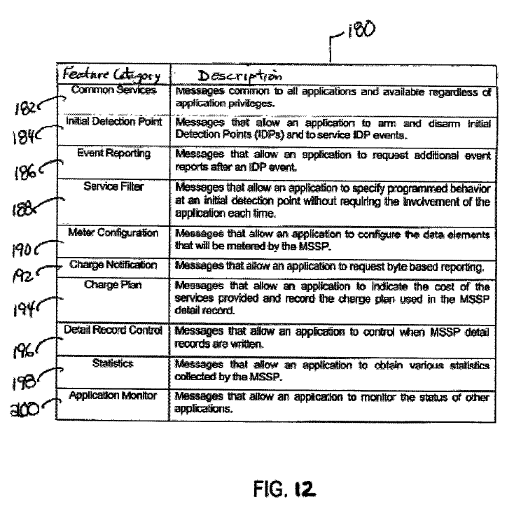

Referring to FIG. 11, a table 170 containing sample error codes is shown.

Capabilities of the MSSP server 22 may be grouped into feature categories. When applications 30 open their session with the MSSP server 22 the applications 30 specify what features they want through the API 28. Each MSSP feature has a corresponding privilege bit. A configuration entry in a MSSP configuration database 32 residing in a MSSP storage device 34 for an application contains a set of feature privileges that control what features the application 30 is authorized to use. Only the requested features that are authorized for the application 30 are granted, and the application 30 is informed of the features that have successfully been obtained in the response to the request. Application attempts to use messages in a feature category that it has not been granted are refused with a privilege error.

Referring to FIG. 12, a table 180 listing feature categories is shown. Feature categories include a common services feature category 182, an Initial Detection Point feature category 184, an Event Reporting feature category 186, a Service Filter feature category 188, a Meter Configuration feature category 190, a Charge Notification feature category 192, a Charge Plane feature category 194, a Detail Record Control feature, category 196. a Statistics feature category 198, and an Application Monitor feature category 200. Messages associated with each of the feature categories 182-200, with their respective format, are listed in Appendix A, and incorporated herein by reference.

Other embodiments are within the scope of the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method comprising:
in a network, receiving messages from an application program in an application program interface (API); and
passing the messages from the API to a control process in a mobile service switching platform (MSSP).

2. The method of claim 1 in which the network is a wireless network.

3. The method of claim 2 in which the wireless network is a second generation wireless network.

4. The method of claim 2 in which the wireless network is a GSM network.

5. The method of claim 2 in which the wireless network is a GPRS-enabled GSM network.

6. The method of claim 2 in which the wireless network is a TDMA network.

7. The method of claim 2 in which the wireless network is a CDMA network.

8. The method of claim 2 in which the wireless network is a UMTS network.

9. The method of claim 2 in which the wireless network is a TETRA network.

10. The method of claim 2 in which the wireless network is a Tetrapol network.

11. The method of claim 2 in which the wireless network is a DECT network.

12. The method of claim 2 in which the wireless network is an AMPS network.

13. The method of claim 2 in which the wireless network is a WLAN.

14. The method of claim 2 in which the wireless network is a third generation wireless network.

15. The method of claim 1 in which the API provides a protocol that allows the application program to control switching and rounting functions in the MS SP.

16. The method of claim 1 in which the API provides a protocol that allows the application program to redirect packet flow through the MSSP on a per-flow basis.

17. The method of claim 1 in which the API provides a protocol that allows the application program to control policy decisions within the MSSP.

18. The method of claim 1 in which the API provides a protocol that allows the application program to arm initial detection points (IDPs) and services associated IDP events in the control process.

19. The method of claim 1 in which the API provides a protocol that allows the application program to disarm IDPs and service associated ICP events in the control process.

20. The method of claim 1 in which the API provides a protocol that allows the application program to request event reports.

21. The method of claim 1 in which the API provides a protocol that allows the application program to specify programmed behavior at a detection point in the control process.

22. The method of claim 1 in which the API provides a protocol that allows the application program to configure data elements that are metered by the control process of the MSSP.

23. The method of claim 1 in which the API provides a protocol that allows the application program to request byte-based reporting.

24. The method of claim 23 in which the reporting is session-based.

25. The method of claim 23 in which the reporting is service interaction based.

26. The method of claim 23 in which the reporting if flow-based.

27. The method of claim 1 in which the API provides a protocol that allows the application program to specify a cost of services provided.

28. The method of claim 27 in which the protocol allows the application program to record a charge plan used in a detail record.

29. The method of claim 28 in which the protocol allows the application program to control when the detail record is written.

30. The method of claim 1 in which the API provides a protocol that allows the application program to obtain statistics for a session managed by the application program.

31. The method of claim 1 in which the API provides a protocol that allows the application program to obtain statistics for a flow managed by the application program.

32. The method of claim 1 in which the API provides a protocol that allows the application program to monitor a status of other applications connected to the control process of the MSSP.

33. An application program interface (API) comprising:
a set of application layer protocols that allows exchange of messages between an external application process and a control process residing in a Mobile Service Switching Platform (MSSP) using Transmission Control Protocol/Internet Protocol (TCP/IP) network services.

34. The method of claim 33 in which the set comprises a protocol that allows the application process to control switching and routing functions in the MS SP.

35. The method of claim 33 in which the set comprises a protocol that allows the application process to redirect packet flow through the MSSP on a per-flow basis.

36. The method of claim 33 in which the set comprises a protocol that allows the application program to control policy decisions within the MSSP.

37. The API of claim 33 in which the set of application layers protocols comprises a protocol that allows the application process to arm initial detection points (IDPs) and services associated IDP events in the control process.

38. The API of claim 33 in which the set of application layers protocols comprises a protocol that allows the application process to disarm initial detection points (IDPs) and services associated IDP events in the control process.

39. The API of claim 33 in which the set of application layers protocols comprises a protocol that allows the application process to request event reports from the control process.

40. The API of claim 33 in which the set of application layers protocols comprises a protocol that allows the application process to specify programmed behavior at a detection point in the control process.

41. The API of claim 33 in which the set of application layers protocols comprises a protocol that allows the application process to configure data elements that are metered by the control process.

42. The API of claim 33 in which the set of application layers protocols comprises a protocol that allows the application process to request byte-based reporting in the control process.

43. The API of claim 42 in which the reporting is session-based.

44. The API of claim 42 in which the reporting is service interaction-based.

45. The API of claim 42 in which the reporting is flow-based.

46. The API of claim 33 in which the set of application layers protocols comprises a protocol that allows the application process to specify a cost of services provided by the MSSP.

47. The API of claim 33 in which the set of application layers protocols comprises a protocol that allows the application process to record a charge plan used in a detail record stored in the MSSP.

48. The API of claim 33 in which the set of application layers protocols comprises a protocol that allows the application process to control when the detail record is written.

49. The API of claim 33 in which the set of application layers protocols comprises a protocol that allows the application process to obtain statistics for a session managed by the application process.

50. The API of claim 33 in which the set of application layers protocols comprises a protocol that allows the application process to obtain statistics for a flow managed by the application process.

51. The API of claim 33 in which the set of application layers protocols comprises a protocol that allows the application process to monitor a status of other application processes connected to the control process.

52. A system comprising:
a Gateway General Packet Radio Service Support Node (GGSN) linked to control process in a Mobile Service Switching Platform (MSSP);
a group of globally connected computers linked to the control process;
an application program interface (API) connected to the control process; and
an application system executing an application process linked to the API.

53. The system of claim 52 further comprising a General Packet Radio Service Support Node linked to the GGSN.

54. The system of claim 53 further comprising a Base Station Controller (BSC) linked to the General Packet Radio Service Support Node.

55. The system of claim 54 further comprising a Base Transceiver Station (BTS) linked to the BSC.

56. The system of claim 55 further comprising a mobile station (MS) linked to the BTS.

57. The system of claim 52 in which the API comprises a set of application layer protocols that allows exchange of messages between the application process and the control process.

58. The system of claim 57 in which the set of application layers protocols comprises a protocol that allows the application process to arm initial detection points (IDPs) and services associated IDP events in the control process.

59. The system of claim 57 in which the set of application layers protocols comprises a protocol that allows the application process to disarm initial detection points (IDPs) and services associated IDP events in the control process.

60. The system of claim 57 in which the set of application layers protocols comprises a protocol that allows the application process to request event reports from the control process.

61. The system of claim 57 in which the set of application layers protocols comprises a protocol that allows the application process to specify programmed behavior at a detection point in the control process.

62. The system of claim 57 in which the set of application layers protocols comprises a protocol that allows the application process to configure data elements that are metered by the control process.

63. The system of claim 57 in which the set of application layers protocols comprises a protocol that allows the application process to request byte-based reporting in the control process.

64. The API of claim 63 in which the reporting is session-based.

65. The API of claim 63 in which the reporting is flow-based.

66. The API of claim 63 in which the reporting is service interaction-based.

67. The system of claim 57 in which the set of application layers protocols comprises a protocol that allows the application process to specify a cost of services provided by the MSSP.

68. The system of claim 57 in which the set of application layers protocols comprises a protocol that allows the application process to record a charge plan used in a detail record stored in the MSSP.

69. The API of claim 68 in which the set of application layers protocols comprises a protocol that allows the application process to control when the detail record is written.

70. The system of claim 57 in which the set of application layers protocols comprises a protocol that allows the application process to obtain statistics for a session managed by the application process.

71. The system of claim 57 in which the set of application layers protocols comprises a protocol that allows the application process to obtain statistics for a flow managed by the application process.

72. The system of claim 57 in which the set of application layers protocols comprises a protocol that allows the application process to monitor a status of other application processes connected to the control process.
